(19) United States
(12) Patent Application Publication
(10) Pub. No.: US 2026/0330882 A1
(43) Pub. Date: Oct. 22, 2026

(54) OPERATING METHOD OF IMAGE ANALYSIS DEVICE

(71) Applicant: Electronics and Telecommunications Research Institute, Daejeon (KR)

(72) Inventors: SuGil CHOI, Daejeon (KR); Moo Seop KIM, Daejeon (KR); Young Mi SONG, Daejeon (KR); Sungjun WANG, Daejeon (KR); Chi Yoon JEONG, Daejeon (KR)

(73) Assignee: Electronics and Telecommunications Research Institute, Daejeon (KR)

(21) Appl. No.: 19/645,374

(22) Filed: Apr. 13, 2026

(30) Foreign Application Priority Data
Apr. 22, 2025 (KR) 10-2025-0052514
Jan. 21, 2026 (KR) 10-2026-0011886

(51) Int. Cl. G06V 40/50; G06F 21/32; G06T 7/00; G06V 10/75; G06V 10/764; G06V 40/14; G06V 40/18

(52) U.S. Cl. CPC G06V 40/53; G06F 21/32; G06T 7/0012; G06V 10/7515; G06V 10/764; G06V 40/14; G06V 40/193; G06V 40/197; G06T 2207/30041; G06T 2207/30101

(57) ABSTRACT

The operating method includes receiving first image data, identifying a plurality of candidate reference points in the first image data, selecting one of the plurality of candidate reference points as a movement reference point, generating second image data by moving the movement reference point based on an image movement policy, determining whether a first biometric authentication feature in the first image data matches a second biometric authentication feature in the second image data, and outputting the second image data in response to determining that the first biometric authentication feature does not match the second biometric authentication feature.

### CROSS-REFERENCE TO RELATED APPLICATIONS

This application claims priority under 35 U.S.C. § 119 to Korean Patent Application No. 10-2025-0052514 filed on Apr. 22, 2025 and Korean Patent Application No. 10-2026-0011886 filed on Jan. 21, 2026, in the Korean Intellectual Property Office, the disclosure of which is incorporated by reference herein in their entirety.

### BACKGROUND

The present disclosure is related to an image analysis device, and more particularly, to a method for operating an image analysis device.

A human eyeball may provide various information such as a health condition or a disease. A fundus image may include internal structures of the eyeball such as a retina, an optic disc, a macula, or a choroid. The fundus image may be used to evaluate a health condition of the human based on the internal structures of the eyeball. An image analysis device may analyze feature points indicating characteristic findings in the fundus image, and the analyzed information may assist in diagnosing the human.

A fundus image may include a blood vessel structure unique to each person. Accordingly, the fundus image may also be used for biometric authentication. Thus, the fundus image may be used not only for medical applications but also for security or authentication purposes. There is a possibility that personal information may be leaked during the process of storing, transmitting, or analyzing the fundus image. Accordingly, there is a need for a technique for analyzing a fundus image while preventing leakage of biometric authentication information.

### SUMMARY

According to an embodiment of the present disclosure, a method for operating an image analysis device is provided.

According to an embodiment of the present disclosure, a method for operating an image analysis device comprises receiving first image data, identifying a plurality of candidate reference points in the first image data, selecting one of the plurality of candidate reference points as a movement reference point, generating second image data by moving the movement reference point based on an image movement policy, determining whether a first biometric authentication feature in the first image data matches a second biometric authentication feature in the second image data, and outputting the second image data in response to determining that the first biometric authentication feature does not match the second biometric authentication feature.

### BRIEF DESCRIPTION OF DRAWINGS

The above and other objects and features will be more apparent from the following description of embodiments, taken in conjunction with the accompanying drawings, in which:

FIG. 1 is a flowchart for describing an operating method of an image analysis device according to an embodiment of the present disclosure.

FIG. 2 is a flowchart illustrating an operating method for identifying a plurality of candidate reference points in FIG. 1 according to some embodiments of the present disclosure.

FIG. 3 is a diagram illustrating an operating method for identifying a plurality of candidate reference points in FIG. 1 according to some embodiments of the present disclosure.

FIG. 4 is a flowchart for describing an operating method of generating the second image data of FIG. 1 according to some embodiments of the present disclosure.

FIG. 5 is a diagram illustrating an operating method for generating the second image data of FIG. 1 according to some embodiments of the present disclosure.

FIG. 6 is a flowchart illustrating an operating method for determining a match of the biometric authentication feature of FIG. 1 according to some embodiments of the present disclosure.

FIG. 7 is a block diagram illustrating an electronic device according to an embodiment of the present disclosure.

### DETAILED DESCRIPTION

Below, embodiments of the present disclosure will be described in detail and clearly to such an extent that an ordinary one in the art easily carries out the present disclosure.

As used herein, each of the phrases “A or B,” “at least one of A and B” “or at least one of B” “A, B, or C” “at least one of A, B, and C” and “B, or at least one of C” including in the claims, may include any one of the items listed together in the corresponding one of the phrases, or all possible combinations thereof.

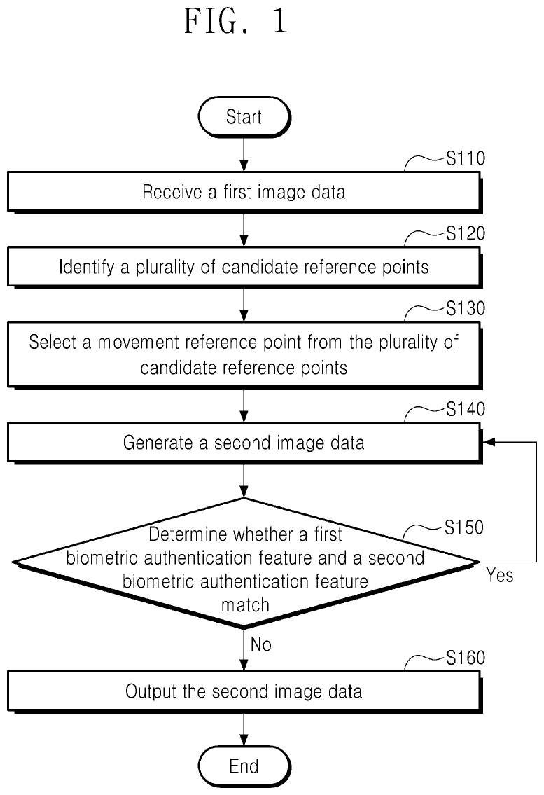

FIG. 1 is a flowchart illustrating an operating method of an image analysis device according to present disclosure. Referring to FIG. 1, in an operation S110, the image analysis device may receive first image data. The first image data may include visual information corresponding to a scene including an object. The first image data may include a plurality of pixels.

In one embodiment, the first image data may include medical information. For example, the first image data may refer to fundus image data of an eyeball captured by an image sensor. The fundus image data may include medical information, such as an optic disc, a macula, or blood vessels, and such various medical information may be used for disease diagnosis.

In an operation S120, the image analysis device may identify a plurality of candidate reference points. The plurality of candidate reference points may indicate a candidate set from which a movement reference point is to be selected.

In some embodiments, the first image data may be fundus image data of an eyeball, and the fundus image data may include a plurality of structures. The plurality of structures may include blood vessels, a macula, and an optic disc. The plurality of candidate reference points may be identified based on the plurality of structures. A detailed description of an operation S120 will be given below.

In an operation S130, the image analysis device may select a movement reference point from a plurality of candidate reference points. The movement reference point may refer to a reference point for moving, copying, or blending a plurality of pixels in the first image data. The image analysis device may select the movement reference point from the plurality of candidate reference points.

In some embodiments, the image analysis device may select the movement reference point in consideration of a blood vessel distribution near the movement reference point. For example, the image analysis device may select the movement reference point in consideration of at least one of a branching pattern, density, or directional distribution of blood vessels located near the movement reference point.

In some embodiments, the image analysis device may select a plurality of movement reference points from the plurality of candidate reference points. Additionally, the image analysis device may select any number of movement reference points from the plurality of candidate reference points.

In an operation S140, the image analysis device may generate second image data by moving the movement reference point based on an image movement policy. The second image data may include a photograph or visual information. In one embodiment, the second image data may include medical information. For example, the second image data may refer to fundus image data.

The image movement policy may refer to information for moving from the movement reference point to a target point. The image movement policy may include the target point, a movement direction, and a movement distance. The target point may indicate a point to which the movement reference point is to move. The movement direction may indicate a direction from the movement reference point to the target point. The movement distance may indicate a distance between the movement reference point and the target point. The image analysis device may determine the image movement policy by setting the target point, the movement direction, and the movement distance to determine the image movement policy.

In one embodiment, the image analysis device may determine the image movement policy in consideration of an interposition relationship between the plurality of structures in the first image data. For example, the image analysis device may adjust the movement direction and/or the movement distance in consideration of at least one of intervals between the plurality of structures, whether there is overlap therebetween, or a relative positional relationship therebetween. The image analysis device may generate the second image data in which an arrangement of the structures is changed while maintaining an overall shape of the first image data.

The second image data may refer to generated image data in which the plurality of structures remain continuous while the first image data is selectively enlarged and reduced. For example, in the second image data, space in some regions of the first image data may be enlarged, while space in other regions of the first image data may be reduced, according to movement of the movement reference point.

In some embodiments, the second image data may be fundus image data, may include the plurality of structures, and an arrangement of the plurality of structures may be changed compared to the first image data. Accordingly, the second image data may enable a disease to be diagnosed based on a distribution of blood vessels, while ensuring personal information protection because it is not determined to be fundus image data of the same person. Detailed descriptions will be given below.

In an operation S150, the image analysis device may determine a first biometric authentication feature in the first image data and a second biometric authentication feature in the second image data, and determine whether the first biometric authentication feature and the second biometric authentication feature match.

The biometric authentication feature may include unique information identified from image data, and may be used for biometric authentication of a human. For example, in response to determining that the first biometric authentication feature and the second biometric authentication feature are the same, the image analysis device may determine that the biometric authentication features are generated from the same person.

In some embodiments, the image data may be fundus image data. The first biometric authentication feature may include a plurality of first feature points generated from the first image data, and the second biometric authentication feature may include a plurality of second feature points generated from the second image data. The image analysis device may determine whether the first biometric authentication feature and the second biometric authentication feature match based on a matching ratio between the plurality of first feature points and the plurality of second feature points.

In addition, in response to determining that the first biometric authentication feature and the second biometric authentication feature match, the image analysis device may determine that the fundus image data are generated by the same person. A more detailed description will be given below.

In response to determining that the first biometric authentication feature and the second biometric authentication feature match, the image analysis device may generate the second image data based on different movement reference points or an image movement policy.

In an operation S160, the image analysis device may output the second image data in response to determining that biometric authentication features of the first image data and the second image data do not match. The second image data may be used for later disease diagnosis of a human.

In one embodiment, the image analysis device may output the second image data to a display device for visual display. For example, the display device may include a liquid crystal display (LCD), an organic light-emitting diode (OLED) display device, or a touch screen.

In one embodiment, the image analysis device may output the second image data to a communication device to transmit the second image data to an external source. For example, the image analysis device may output the second image data to the communication device for transmission to an external server, storage device, or cloud system.

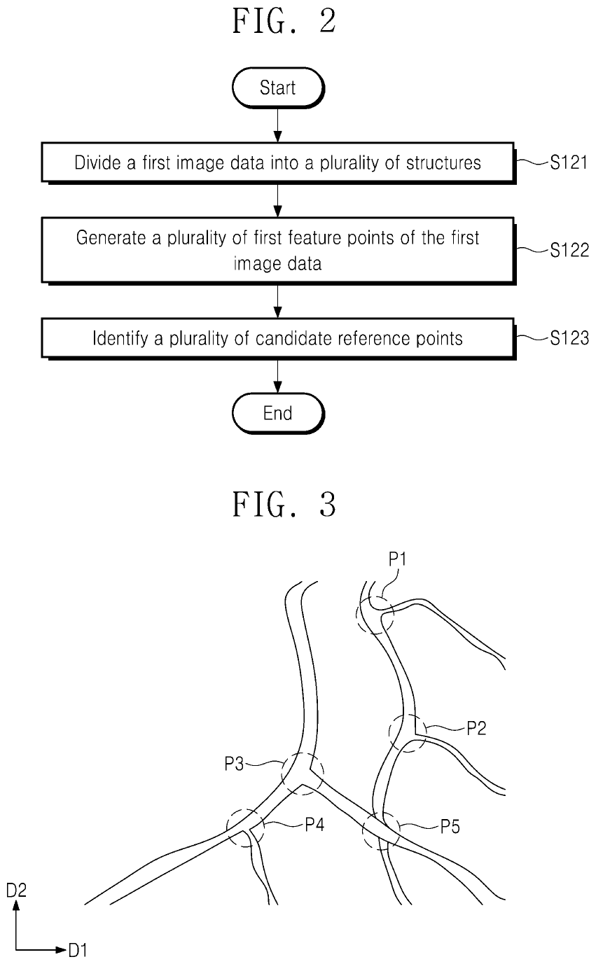

FIG. 2 is a flowchart illustrating an operating method for identifying a plurality of candidate reference points in FIG. 1 according to some embodiments of the present disclosure. Referring to FIG. 2, in an operation S121, an image analysis device may divide first image data into a plurality of structures.

In some embodiments, the image data may also be referred to as fundus image data obtained utilizing an eye of a human. The fundus image data may include a plurality of pixels visually representing an eye, including an optic disc, a macula, and blood vessels. The plurality of pixels may be divided into a plurality of structures. For example, a structure of the fundus image data may include at least one of the optic disc, the macula, or the blood vessels. The optic disc and the macula among the structures of the fundus image data may be the candidate reference points.

In an operation S122, the image analysis device may generate a plurality of first feature points of the first image data. The image analysis device may generate the plurality of first feature points based on pixel values, shape information, or position information of the first image data.

In some embodiments, each of the plurality of first feature points may be generated at a vessel bifurcation point, a vessel crossing point, or a vessel branch point. The image analysis device may generate the plurality of first feature points at positions of the vessel bifurcation point, the vessel crossing point, or the vessel branch point based on the first image data. Detailed descriptions of the vessel bifurcation point, the vessel crossing point, and the vessel branch point will be given below.

In an operation S123, the image analysis device may identify the plurality of candidate reference points in the first image data. The image analysis device may identify the plurality of candidate reference points in the first image data from among the plurality of structures and the plurality of first feature points.

In some embodiments, the image analysis device may identify structures other than blood vessels from the plurality of structures in the first image data and the plurality of first feature points as the plurality of candidate reference points. For example, the image analysis device may identify the optic disc, the macula, the vessel bifurcation point, the vessel branch point, and the vessel crossing point as the plurality of candidate reference points.

FIG. 3 is a diagram illustrating an operating method for identifying a plurality of candidate reference points in FIG. 1 according to some embodiments of the present disclosure. Referring to FIGS. 2 and 3, a portion of first image data is shown.

The first image data may include a plurality of pixels arranged along a first direction D1 and a second direction D2. The first direction D1 may be referred to as a horizontal direction. The second direction D2 may be perpendicular to the first direction D1 and may be referred to as a vertical direction. A plurality of points P1 to P5 included in the first image data may have respective positions on a two-dimensional space formed by the first direction D1 and the second direction D2.

Each of the plurality of first feature points in the first image data may be generated at a vessel bifurcation point, a vessel branch point, or a vessel crossing point. The vessel bifurcation point may refer to a point at which a blood vessel bifurcates into a plurality of blood vessels having similar thicknesses. The vessel branch point may refer to a point at which a blood vessel thinner than a parent vessel extends like a branch. In addition, the vessel crossing point may refer to a point at which different blood vessels intersect. The parent vessel may refer to a blood vessel that is larger than other connected blood vessels.

For example, the first point P1 may refer to the vessel branch point where a blood vessel thinner than the parent vessel branches out from the parent vessel. Similarly, the second point P2 and the fourth point P4 may also refer to the vessel branch points where blood vessels thinner than the parent vessel branch out from the parent vessel.

The third point P3 may indicate the vessel bifurcation point because the two blood vessels have similar sizes and branch from one blood vessel. The fifth point P5 may indicate the vessel crossing point because the blood vessel branching from the third point P3 intersects with the parent vessel at the second point P2 different from the third point P3.

Accordingly, the image analysis device may generate the plurality of first feature points of the first image data at the plurality of points P1-P5. The image analysis device may use the generated plurality of first feature points for identifying the plurality of candidate reference points in a subsequent operation.

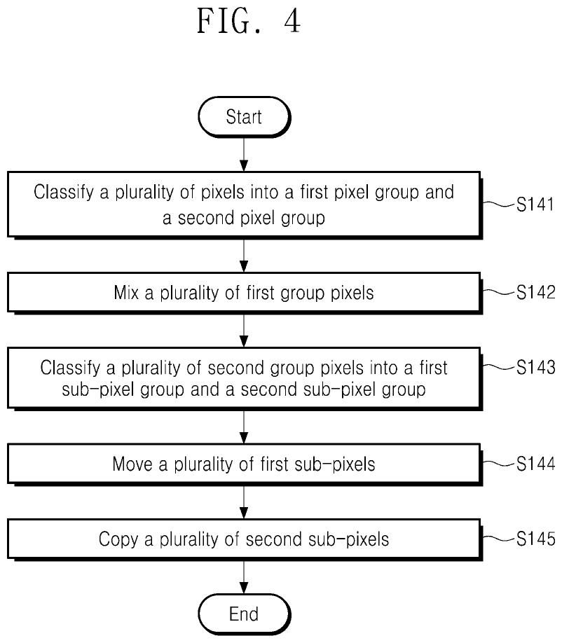

FIG. 4 is a flowchart illustrating an operating method of generating second image data of FIG. 1 according to some embodiments of the present disclosure. Referring to FIGS. 1 and 4, in an operation S141, an image analysis device may classify, based on movement of a movement reference point, a plurality of pixels in a reduced image region of the plurality of pixels in a first image data into a first pixel group, and a plurality of pixels in an enlarged image region into a second pixel group.

For example, the image analysis device may set a plurality of lines connecting pixels located at a boundary of the first image data and the movement reference point as a plurality of connection lines. As the movement reference point moves, positions of the plurality of connection lines may change, and lengths of the plurality of connection lines may increase or decrease.

A region corresponding to connection lines with an increasing length may be an enlarged image region, and a region corresponding to connection lines with a decreasing length may represent a reduced image region. The image analysis device may classify the plurality of pixels of the first image data corresponding to the connection lines with a decreasing length into the first pixel group, and classify pixels of the first image data corresponding to the connection lines with the increasing length into the second pixel group.

In one embodiment, the image analysis device may classify, based on a reference line that passes through the movement reference point and is perpendicular to a movement direction, the plurality of pixels located in the movement direction into the first pixel group and the plurality of pixels located in a direction opposite to the movement direction into the second pixel group.

In an operation S142, the image analysis device may mix a plurality of first group pixels belonging to the first pixel group. The first pixel group may include the plurality of first group pixels. Mixing the first group pixels may refer to combining values of the plurality of first group pixels.

For example, the image analysis device may determine one pixel value by considering the values of the plurality of first group pixels adjacent to each other together. As another example, the image analysis device may apply a weight to each of the values of the plurality of first group pixels and combine the weighted values of the plurality of first group pixel to generate a mixed pixel value.

In an operation S143, the image analysis device may classify the plurality of second group pixels that are not rearranged into the first sub-pixel group, and the plurality of second group pixels that are rearranged into the second sub-pixel group. The second pixel group may include the plurality of second group pixels.

For example, the plurality of second group pixels may be divided into second group pixels that change positions within a region corresponding to an increased length of connection lines due to movement of the movement reference point and second group pixels whose positions are maintained.

The image analysis device may classify the plurality of second group pixels into a first sub-pixel group including the second group pixels are not to be rearranged, and a second sub-pixel group including the second group pixels to be rearranged. Accordingly, the image analysis device may classify the second group pixels into the first sub-pixel group and the second sub-pixel group such that movement or copying of the second group pixels within the to-be-enlarged image region is selectively applied.

In an operation S144, the image analysis device may move a plurality of first sub-pixels included in the first sub-pixel group. The first sub-pixel group may include the plurality of first sub-pixels. The movement of pixels may indicate that the first sub-pixels are repositioned to a new location in the first image data.

For example, the image analysis device may reposition the plurality of first sub-pixels included in the first sub-pixel group in the movement direction of the movement reference point. The image analysis device may move the plurality of first sub-pixels to prevent pixels from being discontinuously distributed in the enlarged image region and ensure connectivity of the structure.

In an operation S145, the image analysis device may copy a plurality of second sub-pixels included in the second sub-pixel group. The second sub-pixel group may include the plurality of second sub-pixels. Copying pixels may refer to arranging the second sub-pixels in second image data without repositioning while maintaining pixel values of the second sub-pixels.

For example, the image analysis device may arrange the plurality of second sub-pixels included in the second sub-pixel group at the same positions in the second image data. The image analysis device may fill the enlarged image region with the second sub-pixels, and ensure structural continuity.

The image analysis device may selectively enlarge and reduce the first image data to generate the second image data, so that the relative positions of the multiple structures included in the first image data may be changed while maintaining the overall size and contour shape of the first image data.

Accordingly, the image analysis device may generate the second image data that is de-identified from the first image data because the disposition of a blood vessel and positions of the blood vessel feature points change. De-identification of image data may refer to changing the image data such that a biometric authentication feature of the image data does not match a biometric authentication feature of an original image data. For example, the de-identified fundus image data may not be determined to be fundus image data of the same person as an original fundus image data.

Since the image analysis device generates the second image data only by using mixing, moving, and copying of pixels without using deletion or overwriting of pixels of the first image data, a problem in which an area including a disease or abnormal finding is removed or concealed may be avoided. Accordingly, the second image data generated by the image analysis device may include medical information and may be de-identified for personal information protection.

In addition, while the second image data may include medical information similar to the first image data, the arrangement of the plurality of structures in the first image data is changed, resulting in a de-identified image, and thus the second image data may be used as training data for an artificial intelligence model.

For example, the second image data may be used as data for training an artificial intelligence model to diagnose retinal disease or detect feature points. Accordingly, the image analysis device may provide the second image data as training data even in an environment where personal information protection is required.

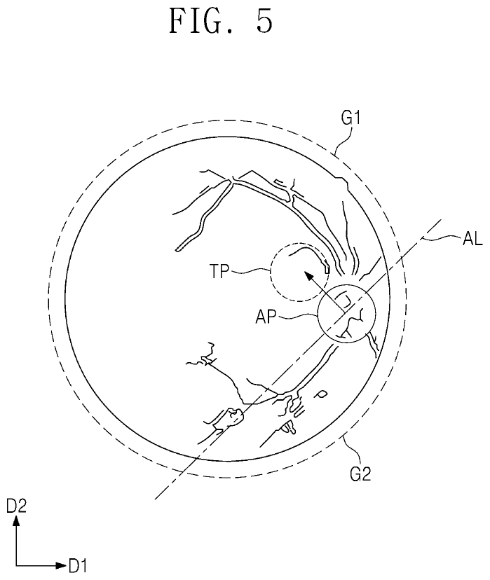

FIG. 5 is a diagram illustrating an operating method of generating second image data of FIG. 1 according to some embodiments of the present disclosure. Referring to FIGS. 1, 4, and 5, first image data, a movement reference point AP, a target point TP, and a reference line AL are shown. The first image data may be located in a two-dimensional space consisting of a first direction D1 and a second direction D2.

The image analysis device may identify a plurality of structures and a plurality of first feature points in the first image data as a plurality of candidate reference points, and select the movement reference point AP from the plurality of candidate reference points. The image analysis device may determine an image movement policy that includes a movement direction and movement distance as long as it does not go beyond a boundary of the first image data.

For example, the image analysis device may identify the optic disc, the macula, and the plurality of first feature points as the plurality of candidate reference points, and select the movement reference point AP from the plurality of candidate reference points. The movement reference point AP may indicate the optic disc from which a blood vessel extends from among the plurality of structures in the first image data.

In an embodiment, the image analysis device may determine the image movement policy in consideration of mutual positions of the plurality of structures in the first image data. For example, the image analysis device may determine the image movement policy including the movement direction and the movement distance for moving to the target point TP at which intervals between blood vessels are wide and no overlap occurs between the blood vessels in consideration of intervals, overlap, or relative positional relationships among the optic disc, the macula, and the blood vessels.

The movement direction may refer to a direction from the movement reference point AP toward the target point TP. The reference line AL may refer to a line passing through the movement reference point AP and perpendicular to the movement direction.

The image analysis device may classify a plurality of pixels of the first image data included in a region corresponding to the movement direction as a first pixel group G1 based on the reference line AL. In addition, the image analysis device may classify the plurality of pixels of the first image data included in a region pointed to by a direction opposite to the movement direction as a second pixel group G2 based on the reference line AL.

The first group pixels included in the first pixel group G1 may include pixels included in a reduced image region among the plurality of pixels of the first image data. The image analysis device may mix the first group pixels to generate pixel values corresponding to the reduced image region.

For example, the image analysis device may select adjacent first group pixels in the to-be-reduced image region, and combine pixel values of the adjacent first group pixels to generate pixel values that mitigate overlap between pixels that may occur due to the reduction.

The second group pixels included in the second pixel group G2 may include pixels included in an enlarged image region in the plurality of pixels of the first image data. The image analysis device may copy and move the second group pixels to generate pixel values of pixels corresponding to the enlarged image region. A first sub-pixels may refer to moving pixels in the second group pixels, and a second sub-pixels may refer to copied pixels in the second group pixels.

The image analysis device may classify a plurality of second group pixels included in the second pixel group G2 into a first sub-pixel group and a second sub-pixel group by dividing the plurality of second group pixels into the plurality of second group pixels to be rearranged and the plurality of second group pixels not to be rearranged.

The image analysis device may move a plurality of first sub-pixels included in the first sub-pixel group. In addition, the image analysis device may copy a plurality of second sub-pixels included in the second sub-pixel group. As a result, the image analysis device may generate the second image data that the first image data is shifted from the movement reference point AP to the target point TP.

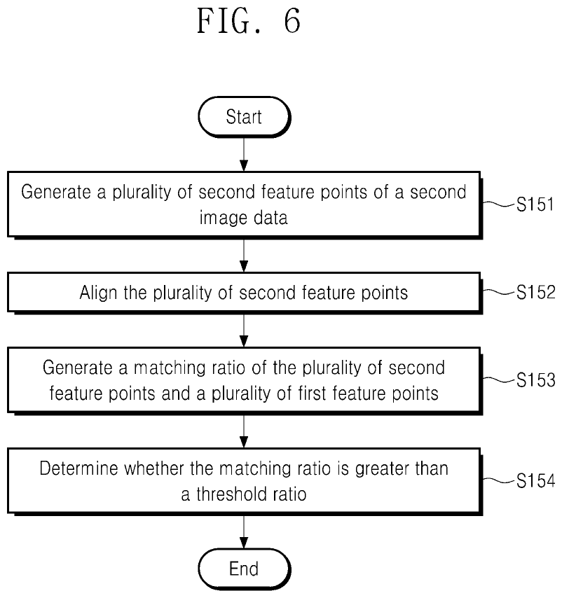

FIG. 6 is a flowchart illustrating an operating method for determining whether biometric authentication features in FIG. 1 match according to some embodiments of the present disclosure. Referring to FIGS. 1 and 6, determining by an image analysis device whether biometric authentication features in first image data and second image data match is shown.

The biometric authentication feature may include feature points of the image data. For example, a first biometric authentication feature may include first feature points, and a second biometric authentication feature may include second feature points.

In an operation S151, the image analysis device may generate a plurality of second feature points of the second image data. In some embodiments, similar to generating a plurality of first feature points of the first image data, the plurality of second feature points of the second image data may each be generated at one of a vessel bifurcation point, a vessel branch point, or a vessel crossing point.

In an operation S152, the image analysis device may align the plurality of second feature points. Alignment of the feature points may refer to rotating or moving the image data such that a number of overlapping or adjacent to feature points of other image data is maximized.

For example, the image analysis device may rotate or move the second image data such that a number of the second feature points of the second image data that overlap or are adjacent to the plurality of first feature points of the first image data is maximized.

In an embodiment, the image analysis device may perform the alignment of feature points to correct for differences in position and/or orientation that occur between image data due to differences in equipment used for imaging, imaging angle, or imaging conditions, even if the fundus image data is obtained from the same person.

In an operation S153, the image analysis device may generate a matching ratio between the plurality of second feature points and the plurality of first feature points. The matching ratio may be generated based on a correspondence relationship between the plurality of feature points of the two image data.

The matching ratio may refer to a ratio of the number of second feature points that overlap with the first feature points or are located within a threshold distance to the total number of the second feature points. The threshold distance may be a value representing an allowable error range for determining that a positional difference between two feature points is an identical feature point, and the image analysis device may set the threshold distance.

For example, the image analysis device may identify a number of second feature points that overlap with the plurality of first feature points or are located within the threshold distance from the plurality of first feature points after alignment, and may generate the matching ratio between the plurality of second feature points and the plurality of first feature points.

In an operation S154, the image analysis device may determine whether the matching ratio is greater than a threshold ratio. The threshold ratio may refer to a value set as a criterion for the image analysis device to determine that the biometric authentication features are the same.

The image analysis device may determine that the biometric authentication features are the same based on determining that the matching ratio is greater than the threshold ratio. The image analysis device may determine that the biometric authentication features are not the same based on determining that the matching ratio is not greater than the threshold ratio.

For example, the image analysis device may determine whether the matching ratio between the plurality of second feature points and the plurality of first feature points is greater than the threshold ratio. In response to determining that the matching ratio is greater than the threshold ratio, the image analysis device may determine that a first biometric authentication feature in the first image data and a second biometric authentication features in the second image data are the same.

In addition, in response to determining that the matching ratio is not greater than the threshold ratio, the image analysis device may determine that the biometric authentication features of the first image data and the second image data are not the same.

In response to determining that the matching ratio is not greater than the threshold ratio, the image analysis device may regenerate the second image data based on another movement reference point or another image movement policy. The image analysis device may regenerate the plurality of second feature points, align the plurality of second feature points with the plurality of first feature points, and generate the matching ratio between the plurality of second feature points and the plurality of first feature points. Accordingly, the image analysis device may determine whether the matching ratio is greater than the threshold ratio.

In some embodiments, the image analysis device may determine that the second image data is de-identified for privacy protection in response to determining that the biometric authentication features are not the same. The fundus image data may include feature points that are unique to each person. Accordingly, de-identification of the fundus image data may reduce security risks. The de-identified second image data may be used as medical information without security risks.

In addition, since the second image data includes the medical information of the first image data and is de-identified image data, it may be used as data for learning or performance verification of an artificial intelligence model without security risks.

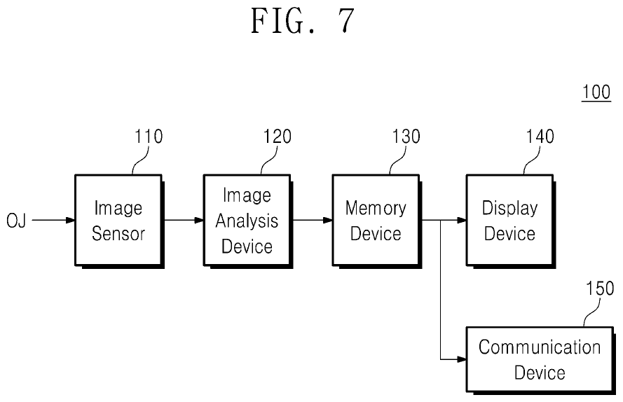

FIG. 7 is a block diagram illustrating an electronic device according to an embodiment of the present disclosure. Referring to FIGS. 1 and 7, the electronic device 100 may include an image sensor 110, an image analysis device 120, a memory device 130, a display device 140, and a communication device 150.

The electronic device 100 may acquire image data from an object OJ. The electronic device 100 may acquire, analyze, store, and output the image data, and may be implemented as a single device or a combination of multiple modules. In some embodiments, the electronic device 100 may include an apparatus for performing medical image processing, biometric authentication, or de-identification processing for privacy protection.

The object OJ may refer to an object from which image data is obtained by the electronic device 100. The object OJ may include a physical object photographed or observed by the electronic device 100. In some embodiments, the object OJ may refer to a human or a part of a human who is subject to biometric authentication or medical image acquisition. For example, the object OJ may refer to a human whose fundus image is photographed, or a part of a human (for example, an eyeball, a retina, a fundus, etc.).

In addition, in some embodiments, the object OJ may refer to a subject serving as a source of image data for medical image processing or artificial intelligence learning. Accordingly, the image data obtained from the object OJ may be used for medical information analysis or de-identification processing for personal information protection.

The image sensor 110 may obtain image data from the object OJ. The image sensor 110 may detect light to generate image data. For example, the image sensor 110 may include a Complementary Metal Oxide Semiconductor (CMOS) sensor, a Charge Coupled Device (CCD) sensor, or a combination thereof.

In some embodiments, the image sensor 110 may generate fundus image data. The image sensor 110 may provide first image data to the image analysis device 120. For example, the image sensor 110 may include a fundus camera or a wide-angle fundus camera, such as an OPTOS device.

The image analysis device 120 may receive the first image data from the image sensor 110. The image analysis device 120 may identify a plurality of structures in the first image data, generate a plurality of first feature points, and identify a plurality of candidate reference points.

In addition, the image analysis device 120 may select a movement reference point of the first image data, determine an image movement policy, and mix, move, or copy a plurality of pixels of the first image data to generate second image data.

In addition, the image analysis device 120 may determine whether a first biometric authentication feature in the first image data matches a second biometric authentication feature in the second image data. The image analysis device 120 may output the second image data to the memory device 130 based on a determination that the biometric authentication features do not match.

For example, the image analysis device 120 may include a computing device, such as a processor (CPU), a microcontroller (MCU), or a digital signal processor (DSP). In addition, the image analysis device 120 may be implemented as a hardware module included in the electronic device 100 or may be implemented in the form of a software module or firmware.

The memory device 130 may store the first image data obtained from the image sensor 110, the second image data generated by the image analysis device 120, and intermediate data or parameters used in a processing procedure of the image analysis device 120. For example, the memory device 130 may include a volatile memory, a non-volatile memory, or a combination thereof.

The display device 140 may receive the first image data and the second image data from the memory device 130. The display device 140 may visually display the first image data and the second image data. For example, the display device 140 may include a liquid crystal display device (LCD), an organic light-emitting diode (OLED) display device, or a touch screen.

The communication device 150 may receive the first image data and the second image data from the memory device 130. The communication device 150 may send the first image data and the second image data to an external device or receive data from the external device by using a wired or wireless communication scheme. For example, the communication device 150 may include a communication module that uses a near-field communication scheme, a mobile communication scheme, or a wired communication scheme.

In an embodiment, the communication device 150 may send the second image data to an external server, a cloud system, or an external biometric authentication system. For example, the electronic device 100 may be coordinated with a cloud-based medical artificial intelligence system through the communication device 150.

As another example, the electronic device 100 may provide the second image data to an external server for artificial intelligence learning or research purposes. The electronic device 100 may respond to a risk of leakage of the fundus image data included in the first image data by sending the de-identified second image data to an external server, a storage device, a cloud system, or an external biometric authentication system.

The components described in the example embodiments may be implemented by hardware components including, for example, at least one digital signal processor (DSP), a processor, a controller, an application—specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the present disclosure. It will be apparent to one of ordinary skill in the art that various modifications of the example embodiments may be made without departing from the spirit and scope of the claims and their equivalents.

The above descriptions are merely illustrative embodiments for implementing the present disclosure. The present disclosure includes not only the above-described embodiments but also embodiments that may be simply or easily modified in design. In addition, the present disclosure includes techniques that may be easily modified and implemented using the embodiments. Therefore, the scope of the present disclosure should not be limited to the above-described embodiments but should be defined by the claims below and equivalents to the claims of the present disclosure.

What is claimed is:

1. An operating method of an image analysis device, comprising:
receiving first image data;
identifying a plurality of candidate reference points in the first image data;
selecting one of the plurality of candidate reference points as a movement reference point;
generating second image data by moving the movement reference point based on an image movement policy;
determining whether a first biometric authentication feature of the first image data matches a second biometric authentication feature of the second image data; and
outputting the second image data in response to determining that the first biometric authentication feature does not match the second biometric authentication feature.

2. The operating method of claim 1, wherein the identifying the plurality of candidate reference points in the first image data comprises:
dividing the first image data into a plurality of structures;
generating a plurality of first feature points based on pixel values, shape information, or position information of the first image data; and
identifying the plurality of candidate reference points based on the plurality of structures and the plurality of first feature points.

3. The operating method of claim 2, wherein each of the plurality of structures comprises at least one of an optic disc, macula, or blood vessel.

4. The operating method of claim 1, wherein the determining whether the first biometric authentication feature of the first image data matches the second biometric authentication feature of the second image data comprises:
generating a plurality of second feature points based on pixel values, shape information, or position information of the second image data;
aligning the plurality of second feature points such that a number of overlapping or adjacent feature points between the plurality of first feature points and the plurality of second feature points is maximized;
generating a matching ratio between the aligned plurality of second feature points and the plurality of first feature points;
determining whether the matching ratio is greater than a threshold ratio; and
determining that the first biometric authentication feature matches the second biometric authentication feature in response to determining that the matching ratio is greater than the threshold ratio.

5. The operating method of claim 4, wherein each of the plurality of first feature points corresponds to at least one of a vessel bifurcation point, a vessel crossing point, or a vessel branch point, and
wherein each of the plurality of second feature points corresponds to at least one of the vessel bifurcation point, the vessel crossing point, or the vessel branch point.

6. The operating method of claim 1, wherein the generating the second image data by moving the movement reference point based on the image movement policy comprises:
classifying a plurality of pixels of the first image data into first pixels and second pixels;
mixing at least some of the first pixels to generate a reduced image region;
classifying the second pixels into first sub-pixels and second sub-pixels; and
generating an enlarged image region by moving at least some of the first sub-pixels and copying at least some of the second sub-pixels.

7. The operating method of claim 6, wherein the classifying the plurality of pixels in the first image data into the first pixels and the second pixels comprises:
classifying the plurality of pixels in the first image data into the first pixels located in a movement direction and the second pixels located in a direction opposite to the movement direction, based on a reference line passing through the movement reference point and perpendicular to the movement direction.

8. The operating method of claim 1, wherein the first image data comprises fundus image data obtained from an image sensor.

9. The operating method of claim 1, further comprising selecting another one of the plurality of candidate reference points, different from the movement reference point, as an additional movement reference point, and
wherein the image movement policy comprises movement of the additional movement reference point.

10. The operating method of claim 1, wherein the second image data is de-identified fundus image data.

11. An electronic device, comprising:
an image sensor configured to obtain first image data from an object;
an image analysis device configured to receive the first image data and output second image data based on an image movement policy;
a display device configured to display the second image data; and
a communication device configured to transmit the second image data to an external device,
wherein the image analysis device configured to:
receive the first image data;
identify a plurality of candidate reference points in the first image data;
select one of the plurality of candidate reference points as a movement reference point;
generate the second image data by moving the movement reference point based on the image movement policy;
determine whether a first biometric authentication feature of the first image data matches a second biometric authentication feature of the second image data; and
output the second image data in response to determining that the first biometric authentication feature does not match the second biometric authentication feature.

12. The electronic device of claim 11, wherein the image analysis device configured to:
divide the first image data into a plurality of structures;
generate a plurality of first feature points based on pixel values, shape information, or position information of the first image data; and
identify the plurality of candidate reference points based on the plurality of structures and the plurality of first feature points, and
wherein each of the plurality of structures comprises at least one of an optic disc, a macula, or a blood vessel.

13. The electronic device of claim 11, wherein the image analysis device configured to:
generate a plurality of second feature points based on pixel values, shape information, or position information of the second image data;
align the plurality of second feature points such that a maximum number of feature points are overlapping or adjacent to the plurality of first feature points;
generate a matching ratio between the aligned plurality of second feature points and the plurality of first feature points;
determine whether the matching ratio is greater than a threshold ratio; and
determine that the first biometric authentication feature matches the second biometric authentication feature in response to determining that the matching ratio is greater than the threshold ratio.

14. The electronic device of claim 13, wherein each of the plurality of first feature points corresponds to at least one of a vessel bifurcation point, a vessel crossing point, or a vessel branch point, and
wherein each of the plurality of second feature points corresponds to at least one of the vessel bifurcation point, the vessel crossing point, or the vessel branch point.

15. The electronic device of claim 11, wherein the image analysis device configured to:
classify the plurality of pixels of the first image data into first pixels and second pixels;
mix at least some of the first pixels to generate a reduced image region;
classify the second pixels into first sub-pixels and second sub-pixels; and
generate an enlarged image region by moving at least some of the first sub-pixels and copying at least some of the second sub-pixels.
